(19) United States
(12) Patent Application Publication
(10) Pub. No.: US 2016/0197947 A1
(43) Pub. Date: Jul. 7, 2016

(54) SYSTEM FOR DETECTING ABNORMAL BEHAVIOR BY ANALYZING PERSONALIZED USE BEHAVIOR PATTERN DURING ENTIRE ACCESS PERIOD

(71) Applicant: KOREA INTERNET & SECURITY AGENCY, Seoul (KR)

(72) Inventors: Chae Tae IM, Seoul (KR); Dong Wan KANG, Seoul (KR); Tae Eun KIM, Anyang-si (KR); Chang Min JO, Seoul (KR)

(21) Appl. No.: 14/598,525

(22) Filed: Jan. 16, 2015

(30) Foreign Application Priority Data
Jan. 6, 2015 (KR) 10-2015-0000989

(51) Int. Cl. H04L 29/06; H04L 29/08

(52) U.S. Cl. CPC H04L 63/1425; H04L 63/1416; H04L 67/306

(57) ABSTRACT

An abnormal behavior detection system includes a context information reception unit receiving a variety of types of context information from a context information collection system, a context information processing unit generating a corresponding detection request message when context information about “termination or access termination” is received and transfer the corresponding detection request message to an abnormal detection unit, the abnormal detection unit detecting an abnormal use behavior by analyze frequency of behaviors in an identical access situation which have occurred during an entire access period through an analysis of a use behavior pattern during the entire access period, a profile management unit profiling pieces of context information according to various use behaviors of the user and store and manage the pieces of profiled context information, and an information analysis unit analyzing web site or DB use information based on the pieces of received context information.

### CROSS REFERENCE TO RELATED APPLICATION

The present application claims the benefit of Korean Patent Application No. 10-2015-0000989 filed in the Korean Intellectual Property Office on Jan. 6, 2015, the entire contents of which are incorporated herein by reference.

### BACKGROUND OF THE INVENTION

1. Technical Field

The present invention relates to a bring your own device (BYOD) and a system for protecting internal resources in a smart work environment, more particularly, to a BYOD and system for detecting an abnormal behavior in a smart work environment.

2. Description of the Related Art

The spread of internet infrastructure and the development of mobile communication have resulted in a significant change that may be a revolution in our society. In particular, mobile devices, such as smart phones, have been deeply seated in our life out of simple communication means. This trend spreads to our jobs at work, and thus a new business environment of a concept of a BYOD has emerged. The BYOD is a concept in which personal devices are used in tasks. The BYOD refers to all the technologies, concepts, and policies for accessing IT resources within companies, such as databases and applications within the companies, and processing tasks using personal mobile devices, such as smart phones, laptops, and tablets. The BYOD may expect speed, efficiency, and productivity of tasks through more efficient task processing and has no economic burden of supplying separate task devices because personal devices are used from a viewpoint of companies. For this reason, many companies are taking into consideration the successful introduction of the BYOD. Furthermore, it has been found that users already use their personal devices in tasks before companies are read.

The formation of the BYOD and smart work environments, that is, new IT environments, has been accelerated due to the construction of wireless Internet environments, the popularization of smart devices, such as tablet PCs and smart phones, the virtualization of desktops, an increase of cloud service utilization, and attaching greater importance to real-time communication and business continuity.

Furthermore, as a BYOD era arrives, infrastructure within a company changes from a closed environment to an open environment. Access to company infrastructure using personal devices are permitted at any time, and anywhere.

Company infrastructure can be accessed using personal devices through wireless sharers (APs) and switches within companies. Company infrastructure may also be accessed using personal devices outside companies over mobile communication networks, Wi-Fi, and VPNs.

As described above, a change to an open environment has obtained business continuity and convenience. In contrast, security threats that have not been expected before may occur. If personal devices access infrastructure within companies, a possibility that data within the companies may leak is increased. That is, there is a possibility that data within companies may leak due to a loss or theft of personal devices, and company IT assets may be threatened because personal devices affected with malware access internal intranets.

### SUMMARY OF THE INVENTION

Accordingly, the present invention has been made keeping in mind the above problems occurring in the prior art, and an object of the present invention is to provide an abnormality detection system for processing information about the situations of BYOD and smart work environments, configuring a user profile, and detecting an abnormal behavior based on the processed information and the configured user profile in order to detect abnormal access using devices and real-time abnormal use behaviors.

Another object of the present invention is to provide an abnormal behavior detection system for analyzing frequency of behaviors in the same access situation that have occurred during the entire access period and detecting an abnormal use behavior by analyzing a user behavior pattern during the entire access period.

Additional characteristics and advantages of the present invention will be described in the following description and will be partially made evident by the description or understood by the execution of the present invention. The object and other advantages of the present invention will be implemented by, in particular, structures written in the claims in addition to the following description and the accompanying drawings.

### BRIEF DESCRIPTION OF THE DRAWINGS

FIG. 1 is an exemplary diagram illustrating BYOD and smart work environments;

FIG. 2 is a block diagram of an abnormal behavior detection system in accordance with an embodiment of the present invention;

FIG. 3 is a block diagram of an abnormal detection unit in accordance with an embodiment of the present invention;

FIG. 4 is a flowchart illustrating the operation of a context information processing unit in accordance with an embodiment of the present invention;

FIG. 5 is a flowchart illustrating the operation of an abnormal detection unit in accordance with an embodiment of the present invention;

FIG. 6A is a diagram illustrating the past behavior information processing table for analyzing and detecting a user behavior pattern during the entire access period;

FIG. 6B is a diagram illustrating a current occurrence context information processing table for analyzing and detecting a user behavior pattern during the entire access period;

FIG. 7 is an exemplary diagram of an operation for analyzing and detecting a user behavior pattern during the entire access period in accordance with an embodiment of the present invention; and

FIG. 8 is a graph illustrating an occurrence probability and errors according to current context information and past use behaviors.

### DESCRIPTION OF REFERENCE NUMERALS OF PRINCIPAL ELEMENTS IN THE DRAWINGS

100: context information collection system

200: abnormal behavior detection system

210: context information reception unit

220: context information processing unit

230: abnormal detection unit

250: profile management unit

260: information analysis unit

270: storage unit

300: control system 400: personal device

500: security system

### DETAILED DESCRIPTION

In accordance with an embodiment of the present invention, an abnormal behavior detection system for detecting an abnormal use behavior of a user in bring your own device (BYOD) and smart work environments includes a context information reception unit configured to receive a variety of types of context information from a context information collection system, a context information processing unit configured to generate a corresponding detection request message when context information about “termination or access termination” is received and transfer the corresponding detection request message to an abnormal detection unit, the abnormal detection unit configured to detect an abnormal use behavior by analyze frequency of behaviors in an identical access situation which have occurred during an entire access period through an analysis of a use behavior pattern during the entire access period when the detection request message is received, a profile management unit configured to profile pieces of context information according to various use behaviors of the user and store and manage the pieces of profiled context information, and an information analysis unit configured to analyze web site or DB use information based on the pieces of received context information.

In accordance with an embodiment of the present invention, an abnormal behavior detection method of detecting an abnormal use behavior of a user in BYOD and smart work environments includes generating a corresponding detection request message when context information about “termination or access termination” is received from a context information collection system and transferring the corresponding detection request message to an abnormal detection unit, detecting an abnormal use behavior by analyzing frequency of behaviors in an identical access situation which have occurred during an entire access period through an analysis of a user behavior pattern during the entire access period, after the abnormal detection unit receives the detection request message and, and generating normal or abnormal detection result information based on a result of the analysis of the continuous use behavior pattern and transferring the normal or abnormal detection result information to a control system.

Hereinafter, some embodiments of the present invention are described in detail with reference to the accompanying drawings in order to those skilled in the art to which the present invention pertains to easily practice the present invention. The same or similar reference numerals are used to denote the same or similar functions throughout the drawings.

A BYOD and smart work service determine whether a user behavior is abnormal in real time by analyzing context information about a user who accesses/uses service within a company and may control the access/use of a corresponding user, if necessary. The abnormal behavior detection system in accordance with an embodiment of the present invention determines whether a user behavior is abnormal based on a previously constructed normal profile, a predetermined security policy, or a behavior that is now being generated.

The context information means information that is collected by a collection system and transmitted to the abnormal behavior detection system and that is related to the access, use, and termination of a user. The profile is an information set that is used to identify a user and that is quantified information of behaviors of the user. The profile is user information that has been accumulated and patterned from the past. A series of behaviors for managing a profile, such as the creation, modification, deletion, and storage of the profile, is called profiling.

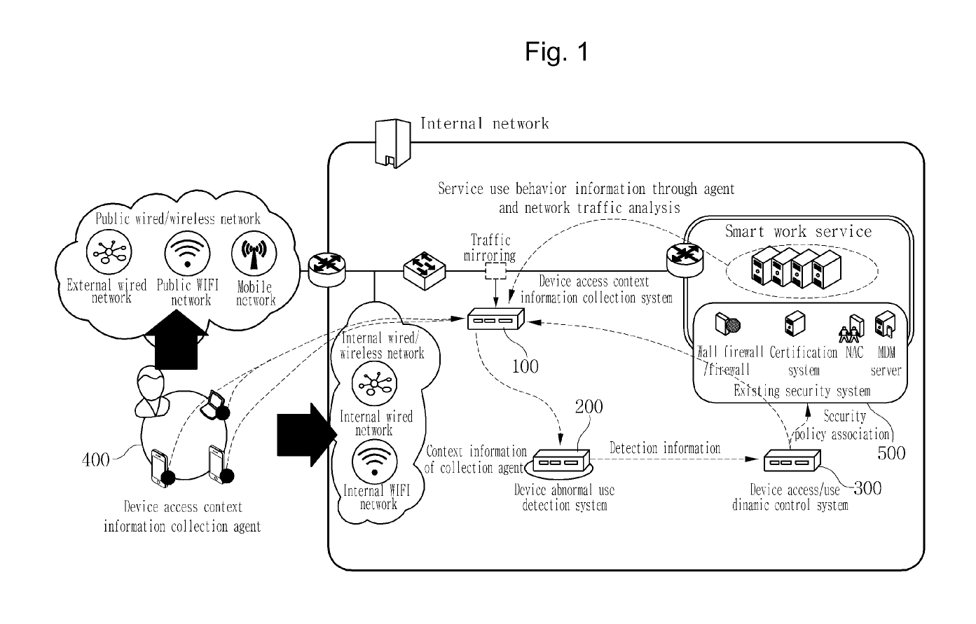

FIG. 1 is an exemplary diagram illustrating BYOD and smart work environments.

As illustrated in FIG. 1, the BYOD and smart work environments are implemented to include a context information collection system 100, an abnormal behavior detection system 200, a control system 300, a personal device 400, and a security system 500 (e.g., an MDM server or an NAC server).

The context information collection system 100 collects pieces of context information related to certification, access, and access termination from the personal device 400 and an MDM agent device.

The collected context information may include an access address (e.g., an ID, his/her place, right, and a current state), access patterns (a result of certification and the number of certification failures), network behavior information (e.g., an access time and a location), and access termination time information. The context information consists of periodic transmission data and real-time transmission data. The context information collection system 100 considers both the periodic transmission data and the real-time transmission data to be real-time transmission data and collects them.

The abnormal behavior detection system 200 basically includes a context information reception unit, a context information processing unit, and an abnormal behavior detection unit. As illustrated in FIG. 1, the abnormal behavior detection system 200 receives context information from the context information collection system 100, detects an abnormal behavior, and sends the detected results to the control system 300 (e.g., dynamic access control middleware).

The abnormal behavior detection system 200 sorts pieces of the context information, received from the context information collection system 100, according to service access sessions, processes the pieces of context information, if necessary, and generates an access ID and a device ID and additional information, such past behavior pattern information. Furthermore, the abnormal behavior detection system 200 patterns accumulated data for each user ID, generates a profile, and updates the generated profile. The abnormal behavior detection system 200 determines whether a user behavior is abnormal using processed information regarding service access and a user in accordance with a security policy and the normal profile of a corresponding user. The detection results of the abnormal behavior detection system 200 are transmitted to the control system 300 in real time.

The control system 300 receives pieces of abnormal behavior information detected by the abnormal behavior detection system 200, performs control through a control GUI or establishes and manages a security policy, and operates in conjunction with external security devices. The control system 300 is connected to the abnormal behavior detection system 300 and external security devices (e.g., GENIAN and WAPPLES).

The personal device 400 is a personal mobile device, such as a smart phone, a laptop computer, or a tablet computer, and is capable of accessing IT resources within a company, such as a database or an application. A user processes tasks through the personal device 400.

The personal device 400 generates context information related to the certification, access, and access termination in the bring your own device (BYOD) and smart work environments. In this case, the context information is the same as that described above.

The security system 500 is placed in a DMZ or screened subnet, and it performs certification connection between an internal network and the personal device 400 and a gateway function for communication, such as direct push update. A plurality of agents accesses the security system 500, thus generating the aforementioned context information.

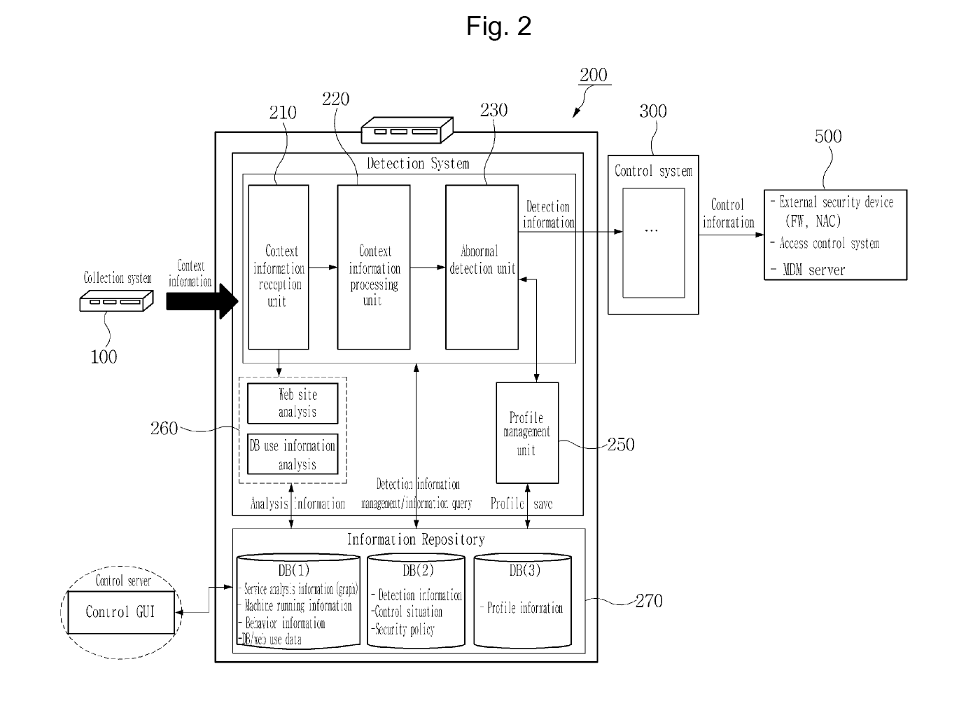

FIG. 2 is a block diagram of the abnormal behavior detection system in accordance with an embodiment of the present invention.

As illustrated in FIG. 2, the abnormal behavior detection system 200 in accordance with an embodiment of the present invention is configured to include a context information reception unit 210, a context information processing unit 220, an abnormal detection unit 230, a profile management unit 250, an information analysis unit 260, and a storage unit 270.

The context information reception unit 210 receives a variety of types of context information, such as the “network access”, “service use”, “access termination” of a user, from the context information collection system 100 physically separated from the abnormal behavior detection system 200 and transfer the variety of types of context information to the context information processing unit 220 and the information analysis unit 260.

All the pieces of context information are transferred to the context information processing unit 220, whereas pieces of user context information, such as web service use request/response information, DB SQL batch request/response information, and DB RPC request/response information, are transferred to the information analysis unit 260. The information analysis unit 260 receives the pieces of context information and analyzes web site and DB use information.

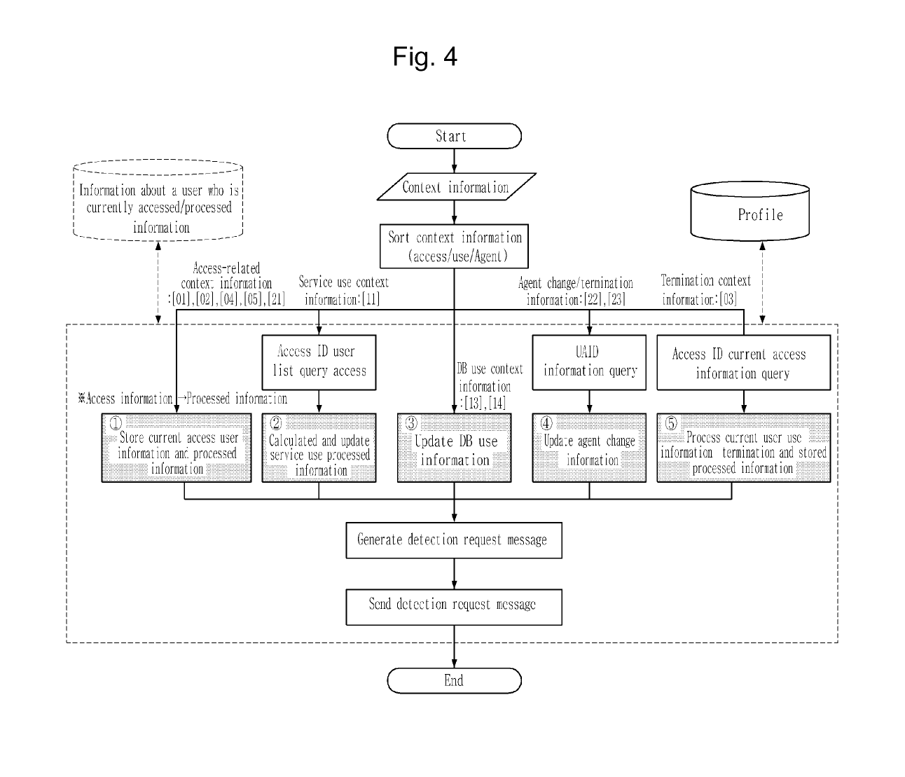

As illustrated in FIG. 4, the context information processing unit 220 sorts pieces of context information received from the context information collection system 100 according to their types, processes the pieces of context information, and stores the pieces of context information based on each access session of a user.

The context information processing unit 220 processes the pieces of context information, such as “network access”, “service use”, and “access termination” received from the context information reception unit 210, and stores the pieces of context information in a temporary repository on one side of the storage unit 270. In this case, the type of temporary repository may be a DB, a file, or memory.

The context information processing unit 220 combines and processes the pieces of context information based on each access ID, stores the pieces of context information in the temporary repository, and uses information processed by a detection module. The access ID may have a combination of an access address and a session ID.

If context information about “network access” is received, the context information processing unit 220 performs a process of adding or updating access information depending on a result of certification and whether user access information is present. The context information related to the “network access” may include a normal certification success, a normal certification failure, enhanced certification, agent installation certification, and agent access information.

If context information about “service use” is received, the context information processing unit 220 updates service use information based on the same access ID.

Furthermore, if context information about “DB use” is received, the context information processing unit 220 updates corresponding information with processed information. Furthermore, if context information about “change of agent” is received, the context information processing unit 220 examines an UAID and updates user's processed information that complies with corresponding information. Furthermore, if context information about “access termination” is received, the context information processing unit 220 updates the termination processing and access termination time of a current access ID.

After all the pieces of context information are received, the context information processing unit 220 generates a detection request message and sends it to the abnormal detection unit 230.

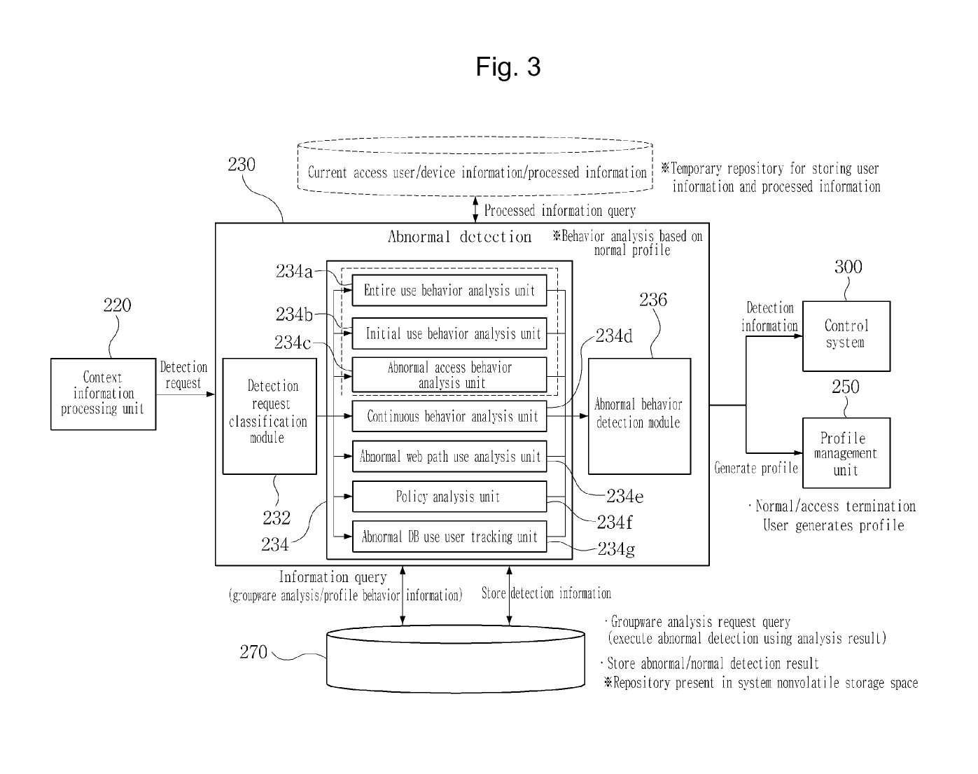

The abnormal detection unit 230 sorts detection request messages and analyzes and detects an abnormal behavior for a user's network use. As illustrated in FIG. 3, the abnormal detection unit 230 is configured to include a detection request classification module 232, an abnormal behavior analysis module 234, and an abnormal behavior detection module 236. FIG. 3 is a block diagram of the abnormal detection unit in accordance with an embodiment of the present invention.

When a variety of types of context information are received, the detection request classification module 232 sorts detection request messages and transfers them to the analysis units 234a to 234g of the abnormal behavior analysis module 234 for executing analyses.

The abnormal behavior analysis module 234 is a module for analyzing a variety of types abnormal behaviors and is configured to include normal profile-based behavior analysis units 234a, 234b, and 234c, a continuous behavior analysis unit 234d, an abnormal web path use analysis unit 234e, a policy analysis unit 234f, and an abnormal DB use user tracking unit 234g. The analysis units 234a to 234g of the abnormal behavior analysis module 234 perform different information analyses depending on the type of received context information.

The normal profile-based behavior analysis units 234a, 234b, and 234c compare a user behavior during the entire access period, an initial use behavior, and an abnormal access behavior with the analysis values of pieces of the past normal profile information and analyze differences from normal behaviors.

The continuous behavior analysis unit 234d analyzes whether pieces of use context information consecutively received in a current access session repetitively execute the same behavior.

The abnormal web path use analysis unit 234e performs a comparison on the URI of use context information that is currently received in the previous service use page of a user through a previously analyzed service web site structure and analyzes an abnormal behavior that is unable to be accessed by the behaviors of the user.

The policy analysis unit 234f determines whether user-processed information that is now being subject to service access and used and a profile is abnormal. The policy analysis unit 234f determines normality and abnormality based on a preset security policy.

A security policy set by an administrator includes control results applied when a series of conditions (or criteria) are satisfied. The security policy of an individual system to be developed is set using user-processed information and the type of information that is used to configure profile information.

If an abnormal behavior is detected according to a policy set based on DB use context information, the abnormal DB use user tracking unit 234g tracks a user who may generate an abnormal behavior using previously written DB-query occurrence information.

If a behavior analysis result is stored in the abnormal behavior analysis module 234, the abnormal behavior detection module 236 determines whether a behavior analysis value is abnormal, generates detection information, and transfers the detection information to the control system 300. If an abnormal behavior is not detected when user access termination context information is received, the abnormal behavior detection module 236 sends a profile creation message to a profile management unit 250. Furthermore, the profile management unit 250 generates a profile based on the contents of normal/access termination.

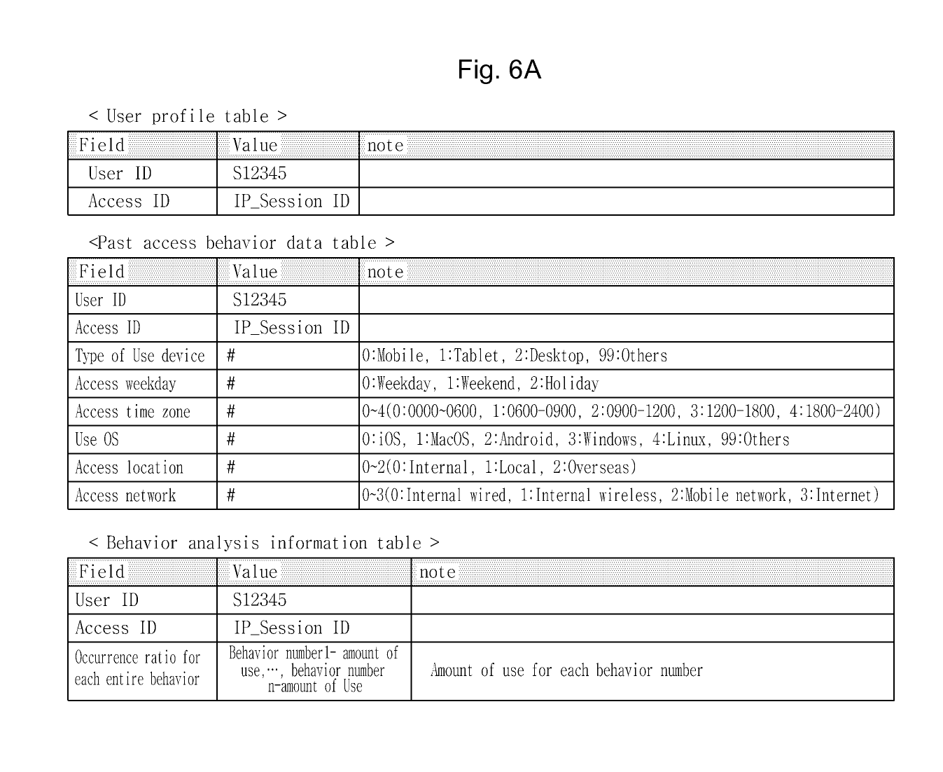

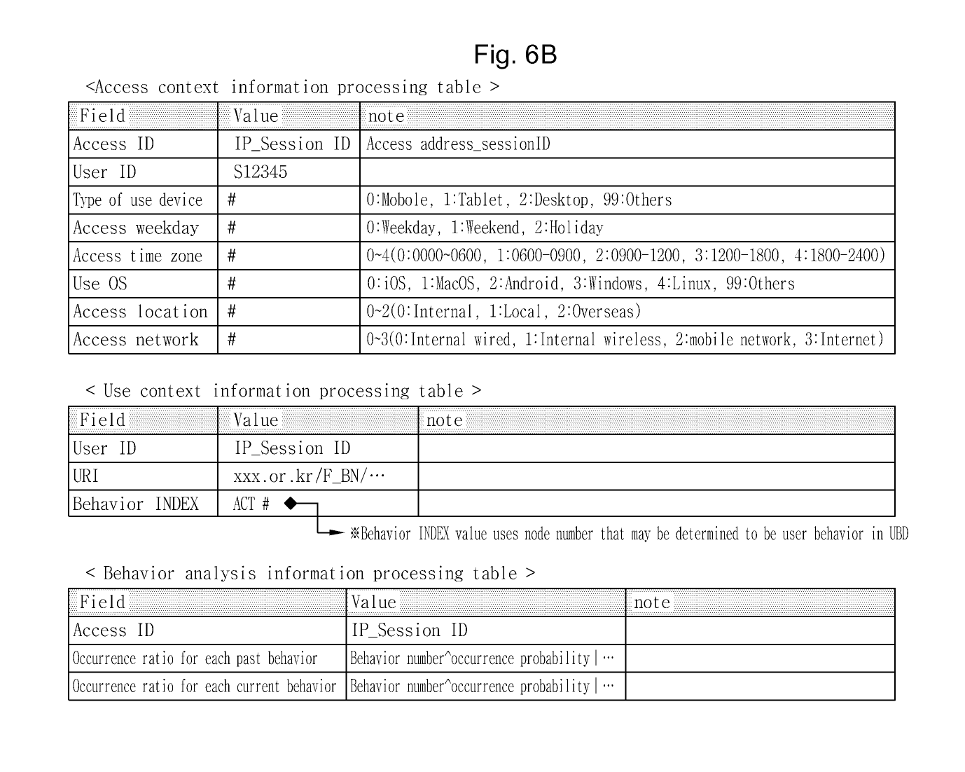

As illustrated in FIG. 6B, the profile management unit 250 generates profile information by profiling pieces of context information according to various use behaviors of a user and stores and manages the profile information.

When the context information reception unit 210 receives a variety of types of context information, such as “network access”, “service use”, and “access termination” related to a user, the information analysis unit 260 analyzes web site and DB use information based on the pieces of received context information.

Next, the storage unit 270 stores profile information and information processed into access, use, and agent context information. Pieces of context information collected by the context information collection system 100 is processed into access, use, and agent context information, and context information upon access termination is processed into profile information and stored in the storage unit 270.

In this case, the stored profile information includes a user profile, a terminal device profile, and an access behavior profile. The user profile includes user right information, a total number of certification failures, the latest access date, the first access date, a total user time, and a total access number. The terminal device profile includes a device ID, a type, an OS, a browser, a device name, MAC, whether an agent has been installed, whether a screen has been locked, installed program information, automatic login setting, and the latest access date. Furthermore, the access behavior profile includes access behavior pattern information.

FIG. 4 is a flowchart illustrating the operation of the context information processing unit 220 in accordance with an embodiment of the present invention.

As illustrated in FIG. 4, the context information processing unit 220 in accordance with an embodiment of the present invention sorts pieces of context information by context information code, processes the pieces of processed information, and stores them in a temporary repository. Pieces of context information received through the context information reception unit 210 are sorted by context information because they are different in the type of information and are stored based on information capable of identifying users, such as an access ID, a user ID, and an UAID.

In the case of “access” context information, if current access information is not present, the context information processing unit 220 generates the “access” context information as new access. If existing access information is present, the context information processing unit 220 updates the corresponding information.

In the case of “service use” context information, the context information processing unit 220 searches for a session that is being accessed based on an access ID, updates service use information, and computes related behavior analysis information.

In the case of “DB use” context information, the context information processing unit 220 continues to store the corresponding information in a repository until the corresponding information is used and deletes the past list of a certain time or more.

Furthermore, in the case of “change of agent/termination information, the context information processing unit 220 searches for a user who has a corresponding UAID and updates change information.

Furthermore, in the case of “termination” context information, the context information processing unit 220 terminates access to a corresponding access ID and updates processed information.

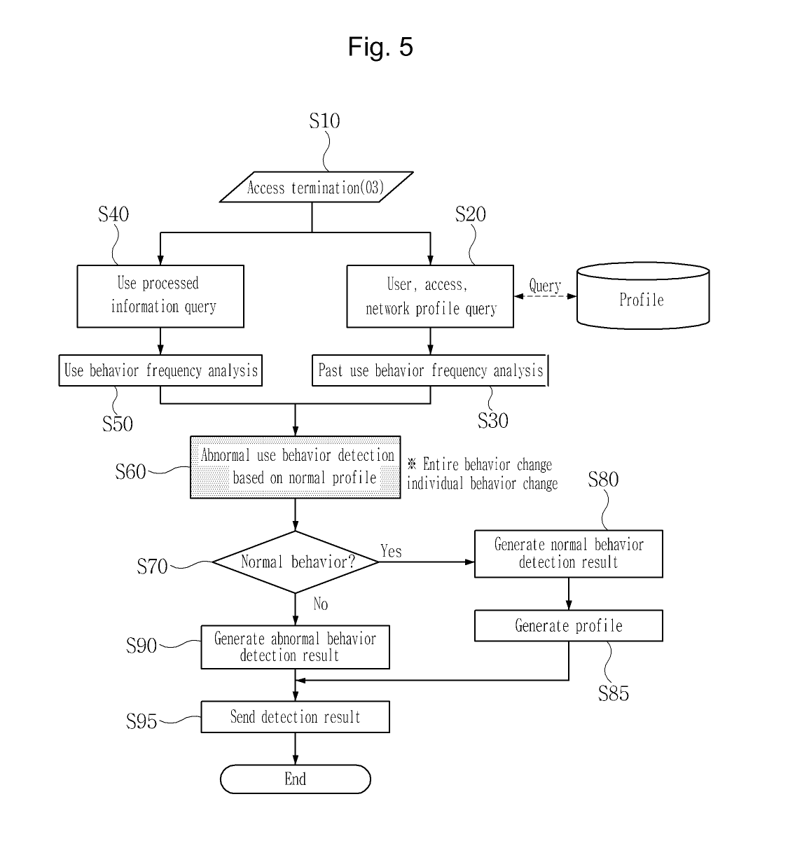

FIG. 5 is a flowchart illustrating the operation of the abnormal detection unit 230 in accordance with an embodiment of the present invention and relates to, in particular, the analysis of a user behavior pattern during the entire access period by the normal profile-based behavior analysis units that form the abnormal detection unit.

The abnormal detection unit 230 in accordance with an embodiment of the present invention sorts detection request messages and analyzes and detects an abnormal behavior for a user's network use. As illustrated in FIG. 3, the abnormal detection unit 230 is configured to include the detection request classification module 232, the abnormal behavior analysis module 234, and the abnormal behavior detection module 236.

The abnormal behavior analysis module 234 is a module for analyzing various patterns of abnormal behaviors and is configured to include the normal profile-based behavior analysis units 234a, 234b, and 234c, the continuous behavior analysis unit 234d, the abnormal web path use analysis unit 234e, the policy analysis unit 234f, and the abnormal DB use user tracking unit 234g.

The normal profile-based behavior analysis units 234a, 234b, and 234c compare a user behavior pattern during the entire access period, an initial use behavior pattern, and an abnormal access behavior pattern with the analysis values of pieces of the past normal profile information and analyze differences from normal behaviors. FIG. 6A is a diagram illustrating the past behavior information processing table for analyzing and detecting a user behavior pattern during the entire access period, and FIG. 6B is a diagram illustrating a current occurrence context information processing table for analyzing and detecting a user behavior pattern during the entire access period.

The normal profile-based behavior analysis unit in accordance with an embodiment of the present invention includes, in particular, the entire use behavior analysis unit 234a and performs pattern analyses of a user behavior during the entire access period, as illustrated in FIG. 3.

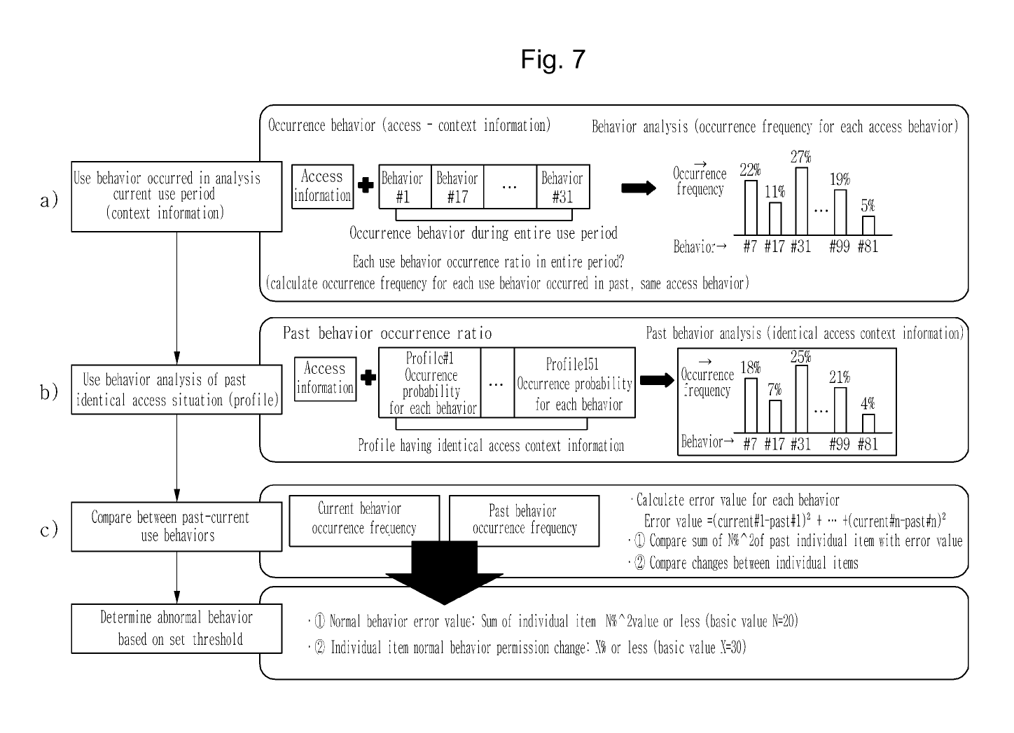

When “termination (or access termination)” context information is input to the abnormal behavior detection system 200 and a corresponding detection request message is received from the context information processing unit 220, as illustrated in b) of FIG. 7, the entire use behavior analysis unit 234a first examines the past profile information of a corresponding user and analyzes frequency of behaviors in the same access situation at steps S10˜S30. FIG. 7 is an exemplary diagram of an operation for analyzing and detecting a user behavior pattern during the entire access period in accordance with an embodiment of the present invention.

Furthermore, as illustrated in a) of FIG. 7, the entire use behavior analysis unit 234a examines use processing information and analyzes frequency of use behaviors that have been generated in current processing information during the entire access period at steps S40 and S50.

Thereafter, as illustrated in c) of FIG. 7, the entire use behavior analysis unit 234a determines whether a user behavior is an abnormal behavior by performing the “detection of a change of all the behaviors” and the “detection of a change of an individual behavior item” of the frequency of use behaviors during current access and the mean of the past access use behaviors at step S60.

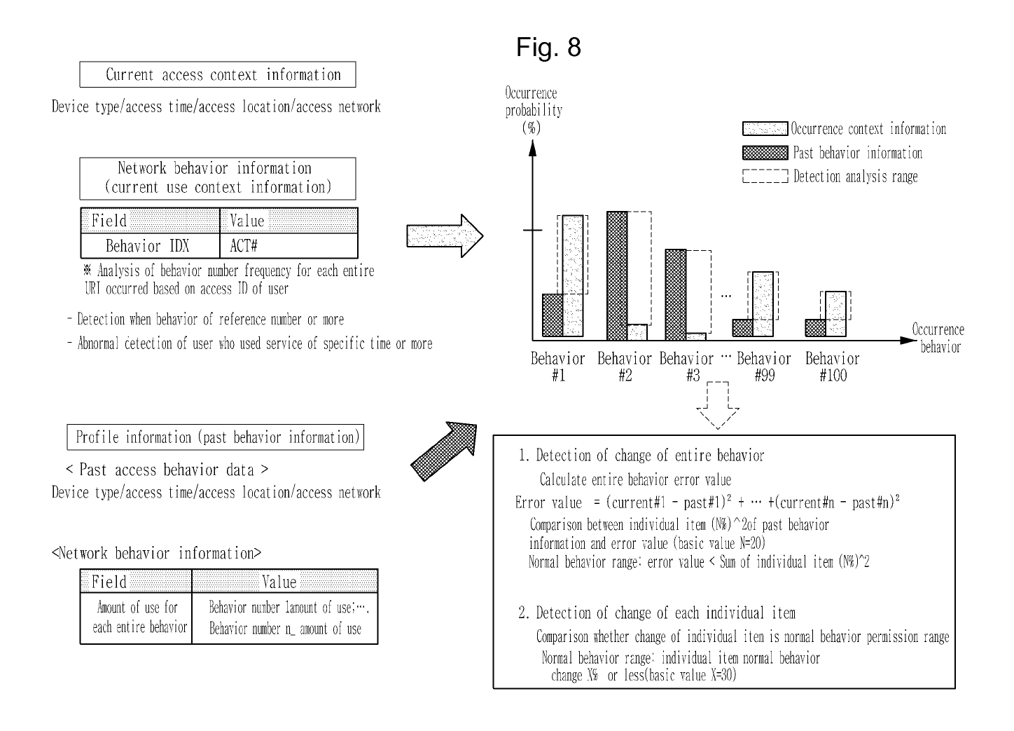

For the “detection of a change of all the behaviors,” first, the entire use behavior analysis unit 234a computes the error value of each behavior as in Equation 1. FIG. 8 is a graph illustrating an occurrence probability and errors according to current context information and past use behaviors.

An error value=(a current use behavior#1−the past use behavior#1)²+ . . . +(a current use behavior#n−the past use behavior#n)² (1)

Furthermore, the entire use behavior analysis unit 234a compares the calculated error value with the sum of (the individual items of the past behavior information N %)̂2. If the calculated error value is smaller than or equal to the individual item of the past behavior information N %̂2, the entire use behavior analysis unit 234a determines the current use behavior of a user to be a normal behavior. If the calculated error value is greater than the individual item of the past behavior information N %̂2, the entire use behavior analysis unit 234a determines the current use behavior of the user to be an abnormal behavior. In this case, the basic value of the N is set to 20.

Furthermore, for the “detection of a change of an individual behavior item”, the entire use behavior analysis unit 234a performs a comparison on a change of an individual item. The individual item means a deviation value of an individual behavior unit that has been calculated in a middle step in order to compute the entire behavior deviation.

If a change of an individual item is X % or less, the entire use behavior analysis unit 234a determines the current use behavior of a user to be a normal behavior and stores a result of the determination (i.e., a result of the analysis). In this case, the basic value of the X is set to 30.

When a result of the analysis of the abnormal behavior analysis module 234 (e.g., the entire use behavior analysis unit 234a) is stored, the abnormal behavior detection module 236 generates corresponding normal or abnormal detection result information and transfers it to the control system 300.

If a result of the determination at step S60 (i.e., a result of the analysis) is determined to be a normal behavior, the abnormal behavior detection module 236 generates a normal behavior detection result. Furthermore, the abnormal behavior detection module 236 generates a corresponding profile at steps S70˜S85.

If a result of the determination at step S60 is determined to be an abnormal behavior, the abnormal behavior detection module 236 generates an abnormal detection result at step S90. Furthermore, the abnormal behavior detection module 236 transfers the generated detection result (e.g., a normal behavior or abnormal behavior) to the control system 300 at step S95. The generated profile information is transferred to the profile management unit 250.

In accordance with an embodiment of the present invention, a user behavior is determined to be a normal behavior only when both the “detection of a change of all the behaviors” and the “detection of a change of an individual behavior item” are determined to be normal.

The abnormal behavior detection system 200 in accordance with an embodiment of the present invention may be implemented into a computer-readable recording medium using software or hardware or a combination of them.

According to hardware implementations, the abnormal behavior detection system 200 described in the present invention may be implemented using at least one of application specific integrated circuits (ASICs), digital signal processors (DSPs), digital signal processing devices (DSPD), programmable logic devices (PLDs), field programmable gate arrays (FPGAs), processors, controllers, microprocessors, and an electronic unit designed to perform a function. In some cases, the embodiments described in this specification may be implemented into the abnormal behavior detection system 200 itself.

As described above, in accordance with an embodiment of the present invention, unlike in existing security equipment based on a network through network traffic analyses, a scheme for patterning a behavior based on various behavior factors, such as the time, location, access network, and use device of a target object, and detecting an abnormal behavior has been implemented.

The abnormal behavior detection system in accordance with an embodiment of the present invention has been intended to improve the system security of BYOD and smart work environments. The abnormal behavior detection system processes pieces of context information into access, use, and agent context information and profile information and detects a behavior, such as the abnormal access and use of a terminal device, through an analysis of a personalized use behavior pattern during the entire access period.

In accordance with an embodiment of the present invention, in order to detect an abnormal access/use behavior, system security in BYOD and smart work environments has been improved using informal data that may occur in task scenarios, that is, the type and access time (e.g., business hours and out of hours) of a user device, an access location (e.g., in the company and outside the company), and a use time as user behavior patterns.

Although the present invention has been described with reference to the embodiments illustrated in the drawings, the embodiments are only illustrative. Those skilled in the art to which the present invention pertains may understand that various other modifications and equivalent embodiments are possible and some of or all the embodiments may be selectively combined. Accordingly, the true scope of the present invention should be determined by the technical spirit of the following claims.

What is claimed is:

1. An abnormal behavior detection system for detecting an abnormal use behavior of a user in bring your own device (BYOD) and smart work environments, the system is configured to comprise:
a context information reception unit configured to receive a variety of types of context information from a context information collection system;
a context information processing unit configured to generate a corresponding detection request message when context information about “termination or access termination” is received and transfer the corresponding detection request message to an abnormal detection unit;
the abnormal detection unit configured to detect an abnormal use behavior by analyze frequency of behaviors in an identical access situation which have occurred during an entire access period through an analysis of a use behavior pattern during the entire access period when the detection request message is received;
a profile management unit configured to profile pieces of context information according to various use behaviors of the user and store and manage the pieces of profiled context information; and
an information analysis unit configured to analyze web site or DB use information based on the pieces of received context information.

2. The abnormal behavior detection system of claim 1, wherein the abnormal detection unit is configured to comprise:
a detection request classification module configured to sort received detection request messages and transfer the sorted detection request messages to analysis units of the abnormal behavior analysis module;
an abnormal behavior analysis module configured to analyze whether the web service use is abnormal by performing a “detection of a change of all behaviors” and a “detection of a change of an individual behavior item” of frequency of behaviors during current access and a mean of past access use behaviors through a use behavior pattern analysis procedure during the entire access period; and
an abnormal behavior detection module configured to generate corresponding normal or abnormal detection result information when a result of the analysis of the abnormal behavior analysis module is stored and to transfer the corresponding normal or abnormal detection result information to the control system.

3. The abnormal behavior detection system of claim 1, wherein the abnormal behavior analysis module is configured to:
detect the frequency of behaviors in the same access situation by examining past profile information of the user,
detect frequency of use behaviors occurred during an entire access period in current processed information by examining use processing information,
calculate an error value for each behavior for a “detection of a change of all behaviors”,
determine whether a current use behavior of the user is abnormal based on the calculated error value, and
determine whether the current use behavior of the user is abnormal as a change of an individual item for a “detection of a change of an individual behavior item.”

4. The abnormal behavior detection system of claim 3, wherein the abnormal behavior analysis module is configured to:
compare the calculated error value with a sum of individual items of past behavior information N %̂2,
determine the current use behavior of the user to be a normal behavior if the error value is smaller than or equal to the individual item of the past behavior information N %̂2, and
determine the current use behavior of the user to be an abnormal behavior if the calculated error value is greater than the sum of the individual items of the past behavior information N %̂2.

5. The abnormal behavior detection system of claim 3, wherein the error value is calculated based on an equation below.
The error value=(a current use behavior#1−a past use behavior#1)²+ . . . +(a current use behavior#n−a past use behavior#n)²

6. An abnormal behavior detection method of detecting an abnormal use behavior of a user in bring your own device (BYOD) and smart work environments, the method comprising:
generating a corresponding detection request message when context information about “termination or access termination” is received from a context information collection system and transferring the corresponding detection request message to an abnormal detection unit;
detecting an abnormal use behavior by analyzing frequency of behaviors in an identical access situation which have occurred during an entire access period through an analysis of a user behavior pattern during the entire access period, after the abnormal detection unit receives the detection request message; and
generating normal or abnormal detection result information based on a result of the analysis of the continuous use behavior pattern and transferring the normal or abnormal detection result information to a control system.

7. The abnormal behavior detection method of claim 6, wherein detecting the abnormal use behavior comprises:
detecting the frequency of behaviors in the same access situation by examining past profile information of the user,
detecting frequency of use behaviors occurred during an entire access period in current processed information by examining use processing information,
calculating an error value for each behavior for a “detection of a change of all behaviors”,
determining whether a current use behavior of the user is abnormal based on the calculated error value, and
determining whether the current use behavior of the user is abnormal as a change of an individual item for a “detection of a change of an individual behavior item.”

8. The abnormal behavior detection method of claim 7, wherein determining whether the current use behavior of the user is abnormal based on the calculated error value comprises:
comparing the calculated error value with a sum of individual items of past behavior information N %̂2,
determining the current use behavior of the user to be a normal behavior if the error value is smaller than or equal to the individual item of the past behavior information N %̂2, and
determining the current use behavior of the user to be an abnormal behavior if the calculated error value is greater than the sum of the individual items of the past behavior information N %̂2.

9. The abnormal behavior detection method of claim 7, wherein the error value is calculated based on an equation below.
The error value=(a current use behavior#1−a past use behavior#1)²+ . . . +(a current use behavior#n−a past use behavior#n)²
